(19) United States
(12) Patent Application Publication
(10) Pub. No.: US 2006/0243713 A1
(43) Pub. Date: Nov. 2, 2006

(54) Method and device for marking identification code by laser beam

(75) Inventors: Kenji Sato, Moriyama-shi (JP); Masaki Mori, Shiga-ken (JP); Yukihiro Uehara, Otsu-shi (JP)

Correspondence Address: RADER FISHMAN & GRAUER PLLC, LION BUILDING, 1233 20TH STREET N.W., SUITE 501, WASHINGTON, DC, 20036, US

(73) Assignee: TORAY ENGINEERING COMPANY, LTD.

(21) Appl. No.: 11/477,945

(22) Filed: Jun. 30, 2006

Related U.S. Application Data
(62) Division of application No. 10/488,964, filed on Mar. 9, 2004.

(30) Foreign Application Priority Data
Oct. 25, 2001 (JP) JP2001-327976
Jan. 23, 2002 (JP) JP2002-13746

(51) Int. Cl. B23K 26/00

(52) U.S. Cl. 219/121.68; 219/121.69; 219/121.77

(57) ABSTRACT

A method and device for marking an identification code on an article to be marked on a stage by means of a laser beam. The laser beam outputted from an exposure unit is so scanned as to deflect in time series in order in a direction perpendicular to the relative movement direction with respect to the stage. The irradiation is shifted synchronously in the relative movement direction. The irradiated points on the article are arranged like orthogonal coordinates. Another method and device is for making arrays of identification codes while one exposure unit is moving by one pitch in the relative movement direction.

This is a divisional application of U.S. Ser. No. 10/488,964, filed Mar. 9, 2004, the entire contents of which is hereby incorporated by reference.

The present application claims priority based on Japanese Patent Application No. 2001-327976, filed Oct. 25, 2001, and Japanese Patent Application No. 2002-13746, filed Jan. 23, 2002, the entirety of which is being incorporated herein by reference

### BACKGROUND OF THE INVENTION

1. Field of the Invention

The present invention relates to a method and device for marking an article to be marked with an identification code by means of a laser beam. More concretely, the invention relates to a method and device for marking a photoresist-coated substrate with an identification code for history management, quality control or the like by means of a laser beam in a manufacturing process or the like of a liquid crystal panel.

2. Description of the Related Art

Generally, in the liquid crystal panel manufacturing process, in addition to exposing the photoresist (namely, a photosensitive resin) coated on a glass substrate to a circuit pattern by a pattern exposing device, the photoresist is exposed to a substrate identification code, a panel identification code, or the like by an identification code exposing device, and further, unnecessary photoresist parts on the peripheral part of the substrate are exposed by a periphery exposing device, and thereafter, the photoresist is developed by a processing device. Thus, the liquid crystal panels are manufactured by dividing the development-processed glass substrate into a plurality of plates.

FIG. 28 illustrates, as an example, a development-processed glass substrate after the exposure processing as described above.

On the glass substrate 50, a large number of liquid crystal panels 51 are arranged in multiple arrays and are exposed. The periphery of the glass substrate is marked with an identification code 50a for history management, quality control, or the like. Moreover, a panel identification code 51a, which is an arrangement number or the like enabling identification and discrimination of particular liquid crystal panels after the glass substrate 50 has been divided into a plurality of liquid crystal panels 51, is marked on each liquid crystal panel. A divided substrate identification code 50b, which is divided-position information for each column and shows to which column the individual liquid crystal panels belonged at the time of division of substrate 50, is then marked at the top of each column. This enables the management of the individual liquid crystal panels 51 in columnar division units.

When a plurality of small-type liquid crystal panels 51 is manufactured from a large type glass substrate 50 separated as mentioned above, the divided substrate identification code 50b and the pane identification code 51a are necessary. However, the names, the number of division or the like such as the substrate identification code 50a, the divided substrate identification code 50b and the panel identification code 51a are only examples, and it goes without saying that they will be changed according to the kinds of liquid crystal panels or the like.

Conventionally, a method for marking the identification codes such as the substrate identification code 50a, the divided substrate identification code 50b, and the panel identification code 51a as mentioned above has been through splitting a single laser beam into a plurality of beams, and selectively irradiating a predetermined position on the glass substrate with the plurality of laser beams while moving the stage with the glass substrate mounted thereon at a constant speed past an exposure unit fixed at a certain position.

However, according to the conventional marking method, when splitting a single laser beam into a plurality of beams, and selectively irradiating the predetermined position on the glass substrate with the plurality of beams as mentioned above, the marking has been carried out while the stage with the glass substrate mounted thereon is moving relative to the exposure unit. Therefore, slippage sometimes has arisen among the irradiation points of the beams, causing unevenness in the beam forms and energy, and it has sometimes been impossible to mark the identification codes with a homogeneous density and form.

Moreover, the conventional method is through carrying out the marking of the identification codes by scanning and irradiating them row by row while moving the stage with the substrate mounted thereon relative to the exposure unit provided with a laser beam irradiation mechanism, therefore, when a liquid crystal panel size is decreased and the panels to be arranged on the substrate are increased in number, the scanning irradiation frequency is inevitably increased, and therefore there has been a problem that the production rate has had to be lowered. As one of the measures to prevent the production rate from being lowered, increasing the number of the exposure units serving one marking device has been considered, but exposure unit installation space needs to be increased if the number thereof is increased, resulting in the problem that the marking device has to be increased in size.

### SUMMARY OF THE INVENTION

The object of the present invention is to provide a method and device for marking identification codes by means of a laser beam which makes it possible to mark the identification codes in a homogeneous density and form when marking the identification codes by means of the laser beam while relatively moving an exposure unit and a stage to each other.

Another object of the present invention is to provide a method and device for marking the identification codes by means of a laser beam improving productivity by making it possible to efficiently mark the identification codes without increasing the device in size.

The method for marking the identification codes of the present invention for achieving the former purpose mentioned above, namely, the method for marking the identification codes on the article to be marked by means of the laser beam, comprising steps of moving a stage mounted with the article to be marked and an exposure unit arranged above the stage relatively to each other, and marking the identification code on the article to be marked by means of the laser beam outputted from the exposure unit, in which the irradiated points on the article to be marked are arranged in orthogonal coordinates by letting the laser beam outputted from the exposure unit scan so as to deflect in time series in order in the direction perpendicular to said relative movement direction, and also by shifting the direction of irradiation in said relative movement direction.

The marking device of the present invention for embodying the above-mentioned method, comprising a stage for mounting thereon an article to be marked and an exposure unit arranged above the stage so that they are relatively movable to each other, in which the exposure unit is comprised of a beam deflection means for letting the laser beam outputted from the exposure unit scan so as to deflect in time series in order in the direction orthogonal to the relative movement direction, and a direction correction means for shifting the irradiation direction of the laser beam deflected by the beam deflection means in the relative movement direction.

Moreover, another marking method for achieving the former purpose mentioned above, namely, the method for marking the identification codes on said article to be marked by means of the laser beam, comprising steps of moving a stage mounted with the article to be marked and an exposure unit arranged above the stage relatively to each other, and marking the identification code on the article to be marked by means of the laser beam outputted from the exposure unit, in which the irradiated points on the article to be marked are arranged in orthogonal coordinates by tilting the orthogonal coordinates on the surface of the stage or the article to be marked on the stage with respect to said relative movement direction, and letting the laser beam outputted from the exposure unit scan so as to deflect in time series in order in the direction orthogonal to the relative movement direction.

The device of the present invention for embodying another marking method mentioned above, comprising a stage for mounting thereon the article to be marked and an exposure unit arranged above the stage so that they are relatively movable to each other, in which the exposure unit comprises a beam deflection means for tilting the orthogonal coordinates on the surface of the stage or the article to be marked on the stage with respect to the relative movement direction and letting the laser beam outputted from the exposure unit scan so as to deflect in time series in order in the direction orthogonal to the relative movement direction, a projection optical means for magnifying the laser beam deflected by the beam deflection means, and a direction correction means for changing the irradiate direction of the laser beam projected from the projection optical means.

According to the present invention described above, since the laser beam outputted from the exposure unit is made to scan being deflected in time series one by one in the direction orthogonal to the relative movement direction and the direction of irradiation is corrected so that an irradiation time difference between the beams adjacent to each other in the direction orthogonal to the relative movement, each beam does not largely vary in the energy distribution and form, and identification codes can homogeneously be marked in form and density.

Moreover, the marking method of the present invention for achieving the latter purpose mentioned above, comprising steps of irradiating the article to be marked with the laser beam from the exposure unit while relatively moving the stage mounted with the article to be marked and the exposure unit arranged above the stage, and a plurality of identification codes is marked in a matrix form of a plurality of rows at a predetermined pitch in the relative movement direction, in which the identification codes of two or more rows are marked while said one exposure unit is moving by one pitch in the relative movement direction.

Moreover, the device of the present invention for embodying the marking method mentioned above, comprising a stage for mounting thereon an article to be marked and an exposure unit arranged above the stage so that they are relatively movable to each other, the exposure unit being provided with a laser beam irradiation mechanism for marking a plurality of identification codes on the article to be marked at a predetermined pitch in the relative movement direction in a matrix form of a plurality of rows, and the laser beam irradiation mechanism being provided with an angle varying means for varying the irradiate direction of the laser beam irradiation mechanism in the direction crossing the relative movement direction.

According to the present invention mentioned above, since a plurality of arrays can be marked by marking the identification codes of the adjacent array by utilizing a blank period in which the exposure unit relatively moves one pitch, two times or more number of identification codes can be marked during one-pitch relative movement as in the conventional marking method. Therefore, the manufacture can be increased in volume without increasing the device in size such as increasing the exposure unit in number.

### BRIEF DESCRIPTION OF THE DRAWINGS

FIG. 1 is a schematic view showing an example of a device for marking identification codes according to the present invention.

FIG. 2 is an output graph that shows an example of a laser beam to be used according to the present invention.

FIG. 3(a) to (d) are illustration views showing the states in which the laser beam is operated to deflect by a beam deflection mechanism on the device according to the present invention.

FIG. 4 is an illustration view showing the state in which a substrate is exposed with the laser beam on the device according to the present invention.

FIG. 5 is an illustration view showing a mirror reflection mechanism for changing the direction of the laser beam irradiation on the device according to the present invention.

FIG. 6 is an illustration view showing another mirror reflection mechanism for changing the direction of the laser beam irradiation on the device according to the present invention.

FIG. 7 is an illustration view showing further another mirror reflection mechanism for changing the direction of the laser beam irradiation on the device according to the present invention.

FIG. 8 is an illustration view showing a method, not according to the present invention, for exposing a substrate.

FIG. 9 is an illustration view showing a method according to the present invention for exposing a substrate.

FIG. 10 is an illustration view showing another example of a method for exposing a substrate by the method according to the present invention.

FIG. 11 is a drawing that shows variations depending on time in the deflection angle of the continuously outputted laser beam to be used for the present invention.

FIG. 12 is an illustration view of the case in which the deflected beam is not transformed into parallel light but is condensed only through a projection lens.

FIG. 13 is a schematic view showing another example of the marking device using a laser beam according to the present invention.

FIG. 14 is a schematic view showing another example of the beam deflection mechanism used on the device shown in FIG. 13.

FIG. 15 is an illustration view of an identification code marked based on the present invention.

FIG. 16 is an illustration view showing another example of an identification code marked based on the present invention.

FIG. 17 is an illustration view of a marking device shown as an example according to another embodiment of the present invention.

FIG. 18 is an illustration view showing marking operation of a plurality of arrays by the marking device shown in FIG. 17.

FIG. 19 is an illustration view showing a sequence of irradiation by scanning when exposing a panel identification code on the substrate shown in FIG. 29 by the method according to the present invention.

FIG. 20 is an illustration view showing a sequence of irradiation by scanning when exposing a panel identification code on the substrate shown in FIG. 29 by the method according to the present invention.

FIG. 21 is an illustration view showing another example of the marking operation of a plurality of arrays by the method according to the present invention.

FIG. 22 is an illustration view showing a further example of the marking operation of a plurality of arrays by the method according to the present invention.

FIG. 23 is an illustration view showing still a further example of the marking operation of a plurality of arrays by the method according to the present invention.

FIG. 24 is an illustration view showing another important example of the marking operation of a plurality of arrays by the method according to the present invention.

FIG. 25 is an illustration view showing an additional example of the marking operation of a plurality of arrays by the method according to the present invention.

FIG. 26 is an illustration view showing an even further example of the marking operation of a plurality of arrays by the method according to the present invention.

FIG. 27 is a drawing of a marking image of an identification code.

FIG. 28 is a plane view illustrating an example of a substrate processed for development after exposure process.

FIG. 29 is a plane view illustrating an example of an identification layout on a substrate including a large number of planes to be taken.

### DETAILED DESCRIPTION OF THE PREFERRED EMBODIMENT

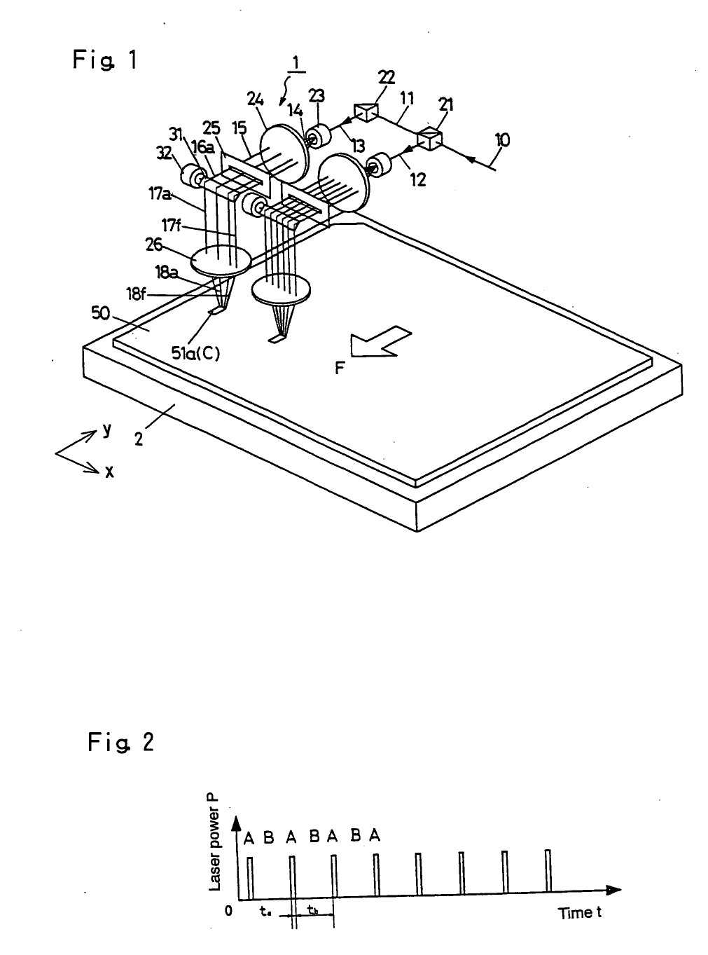

FIG. 1 shows an example of a device for marking identification codes by means of a laser beam according to the present invention to achieve the former purpose stated above.

The reference numeral 1 is an exposure unit, and the reference 2 is a stage for holding a substrate 50 on the upper surface. The substrate 50 is coated with a photoresist (namely, a photosensitive resin) on the surface, and is mounted on the stage 2 as an article to be marked. In the figure, only two sets of exposure units 1 are arranged in parallel, but they may be arranged in many arrays in the direction over the whole width of the substrate 50.

The substrate 50 coated with the photoresist on the surface is brought on the stage 2 by a conveyance mechanism such as an unillustrated transfer robot or a conveyor. When the long side direction and the short side direction of the rectangle stage, when viewed from top, are defined as the X axis direction and the Y axis direction of the orthogonal coordinates, respectively, the stage 2 is provided with drive mechanisms for moving it independently in the X axis direction and the Y axis direction, and a rotary mechanism (both are not illustrated) for turning the stage with an axis vertical to the surface. Furthermore, the surface has a large number of suction holes and is provided with a plurality of substrate supporting pins (not illustrated) so that they rise and set.

The substrate 50 brought in by the conveyance mechanism is mounted on the substrate supporting pins projected on the surface of the stage 2. Following this, the substrate 50 is lowered as the substrate supporting pins descend, and is then held by suction on the surface of the stage 2 by the negative pressure action through the suction holes.

Since the substrate 50 is not always positioned at a definite place on the stage 2, displacements from the pre-registered reference position are measured, and the substrate is set at the reference position based on the measured values. Although the measuring method of the position is not specially restricted, the displacements can be measured by a displacement measuring method or the like using a displacement sensor or a CCD camera. Alternatively, the method can be such as the substrate is brought in register by holding it from the side into the reference position before letting the stage 2 hold the substrate 50 thereon.

The stage 2 holding the substrate 50 is moved to an exposure start position of the identification code by numerical control based on the pre-registered data. The exposure start position is registered by pre-operation, and is set to the state in which the displacements are calculated for correction.

The exposure unit 1 outputs a single laser beam 10 in a pulse train from a laser light source (not illustrated), and the laser beam branches into a straight-going laser beam 11 and a laser beam 12 changed in the direction through a beam splitter 21. The pulse output of the laser beam 10, for example, as shown in FIG. 2, alternately repeats light emission A for a time tₐ and extinction B for a time t_{b} pulse-wise at high speed.

The exposure unit 1 makes the single laser beam 10 outputted from the laser light source (not illustrated) branch into the beams 11 and 12 through the beam splitter 21, and the straight laser beam 11 is changed in the angle through a prism 22. As an angle changing means, a mirror can also be used instead of the prism 22. Both of the laser beams 12 and 13 changed in angles after branching pass through a beam deflection mechanism 23 into laser beams 14, 14a to 14f, 14z, respectively, which are changed in angles in time series by this beam deflection mechanism 23. These laser beams are corrected into parallel beams 15, 15a to 15f, 15z through a lens 24.

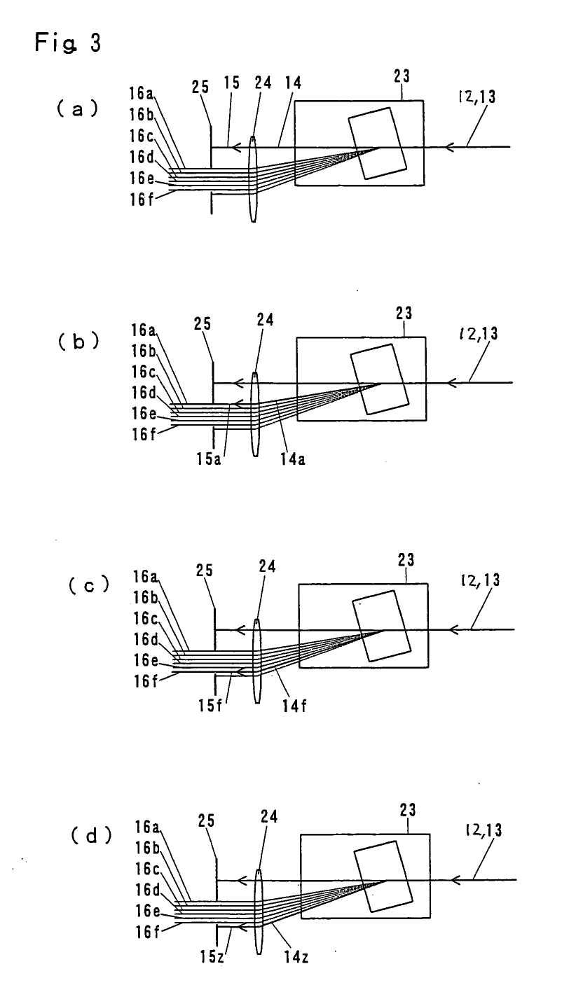

Following this, in order to irradiate only a predetermined position on the substrate 50, the parallel beams 15, 15a to 15f, 15z are processed so that the beams 15 and 15z in the excessive ranges are cut off through a transmission filter 25 as shown in FIG. 3(a) to (d).

FIG. 3(a) illustrates the outgoing situation of the laser beams not deflected by the beam deflection mechanism 23 (what is called zero order beam). The zero-order laser beam 14 irradiated without being deflected passes through the lens 24, and becomes a zero-order laser beam 15 to be shaded with the transmission filter 25. Moreover, as long as a transmission filter is able to choose from among the beams that have passed through the beam deflection mechanism 23, it can substitute for the transmission filter 25, and for example, an aperture or the like can be used. In addition, the transmission filter 25 does not have to be placed downstream from the lens as shown in the figure, but has only to be placed between the beam deflection mechanism 23 and the substrate 50 which is the article to be marked.

FIG. 3(b) to (d) illustrate the outgoing situation of the laser beams (what is called first order beam) which are changed in angles and selectively irradiated by the beam deflection mechanism 23. When a control signal (not illustrated) of a constant frequency is applied to the beam deflection mechanism 23 by using what is called an acoustooptic effect, the primary laser beam 14a deflected as shown in FIG. 3(b) is outgone in addition to the non-deflected zero-order laser beam. This primary laser beam 14a is transformed into a parallel primary laser beam 15a by passing through the lens 24, and passes through the transmission filter 23, to become a selectively irradiated primary laser beam 16a.

A deflection angle of the primary laser beam outgone from the beam deflection mechanism 23 varies with the frequencies of an electric signal applied thereto. As shown in FIG. 3(c), the primary laser beam 14f irradiated with deflection is transformed into a primary laser beam 15f of parallel light by passing through the lens 24, and passes through the transmission filter 25, to become a selectively irradiated primary laser beam 16f Moreover, as shown in FIG. 3(d), the primary laser beam 14z passes through the lens 24 and then becomes the primary laser beam 15z to be shaded with the transmission filter 25.

In addition to these zero order beam and first order beam, such rays called as negative first order beam or second order beam and rays with other modulator are outgone from the beam deflection mechanism 23. However, since these rays are shaded with the transmission filter 25 or with their own chassis, or since their energy is weak, they cause little problem even if they are treated as not outgone.

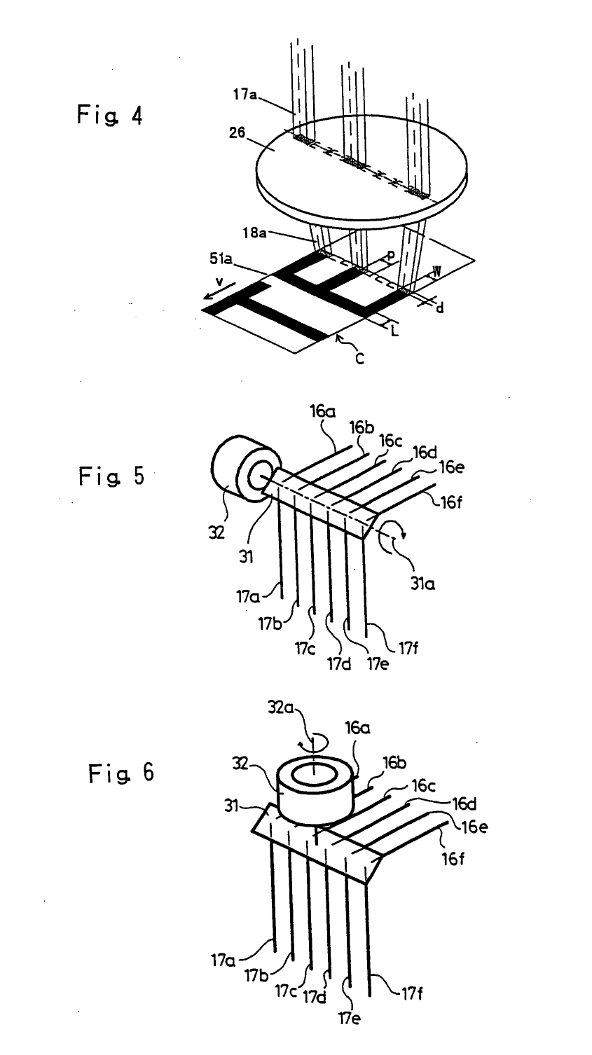

The laser beam 16a to 16f that have passed through the transmission filter 25 are then reflected by an angle variable mirror 31 so as to be changed in the irradiation direction, and are outgone as laser beams 17a to 17f (refer to FIG. 5). As shown in FIG. 4, the laser beams 17a to 17f made to change the direction are transformed into the laser beams 18a to 18f condensed through a condenser lens 26, and are irradiated on the substrate 50 to expose the photoresist on the surface. Thus, an identification code C (51a) consisting of characters and/or two-dimensional figure(s) is marked by the integration of the exposure points of these laser beams 18a to 18f.

As shown in FIG. 1, while the stage 2 is being moved at a constant speed v in a direction of an arrow F, this identification code C (51a) is marked by scanning and exposing the stage 2 with a plurality of laser beams 18a to 18f in time series in order in the direction orthogonal to the direction of the movement.

When a mirror 31 is fixed at a certain angle in the marking of this identification mark, and the laser beams 18a to 18f are made to scan in order the substrate 50 moving in the direction of the arrow F so as to be orthogonal to the movement direction, the exposure direction of the exposure points a, b, c, d, e, f is sequentially and diagonally deflected from the movement direction F (refer to FIG. 8). Following this, the exposure points g, h, I, j, k, l to be scanned with the laser beams 18a to 18f, and the following exposure points m, n, o, p, q, r are also displaced diagonally, therefore, the identification code C is deformed.

Moreover, concerning the exposure points a, b, c, . . . , q, r shown in the figure, the points circled by a full line means actually exposed points, and the points circled by a broken line mean the points which have not been irradiated with the laser beams and not exposed therewith. Correctly speaking, these broken line points are non-exposure points, but they are represented as exposure points by displaying them with a broken line for the sake of convenience.

In the exposure unit according to the present invention, as shown in FIG. 5, the mirror 31 is arranged so as to be turned in the direction of the arrow centering a rotary shaft 31a parallel to the longitudinal direction by a mirror turning mechanism 32. Therefore, the irradiated directions of the reflected laser beams 17a to 17f are shifted in time series in order in the movement direction F of the stage 2 (substrate 50). Accordingly, as shown in FIG. 9, the scanning points of the laser beams 18a to 18f are diagonally shifted one by one synchronously with the movement of the stage 2 in the movement direction. As a result, the exposure points a, b, c, d, e, f, the next exposure points g, h, I, j, k, l, and the further next exposure points m, n, o, p, q, r are arrayed in the state according to orthogonal coordinates. Consequently, the identification code C homogeneously arrayed in a latticed form is marked.

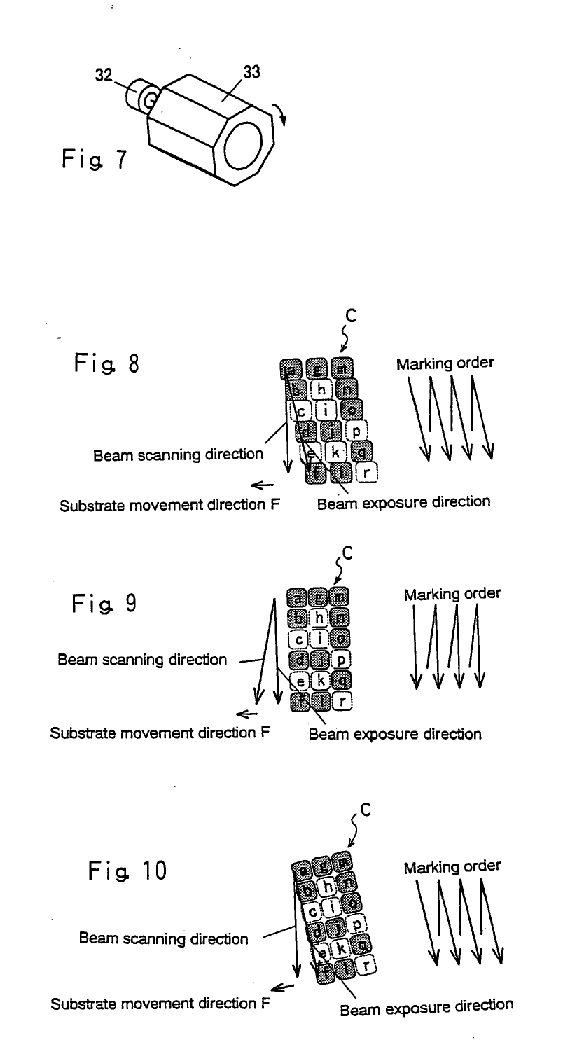

In the embodiment illustrated, the method for diagonally tilting the scanning direction from the movement direction F of the stage 2 (substrate 50) is through turning the reflection mirror 31, but as shown in FIG. 6, the method may be such that a rotary shaft 32a is mounted at the longitudinal center of the reflection mirror 31 so as to be orthogonal thereto, and this rotary shaft 32a is turned in the direction of the arrow by the mirror turning mechanism 32. Moreover, as shown in FIG. 7, the method may be such that a polygon mirror 33 is used instead of the reflection mirror, and the polygon mirror 33 is rotated about its rotary shaft by the mirror turning mechanism 32.

Moreover, it is also possible to use a prism, a double prism, other shapes and means instead of the mirror mentioned above.

Any of the above methods is through making the reflection plane of the mirror variable, but as shown in FIG. 9, the fitting angles of the exposure unit 1 and the reflection mirror 31 are altered in advance, and the beam scanning direction is not orthogonal to the movement direction of the substrate but is provided with a certain angle thereto. As a result, even when the beam exposure direction is set so as to be orthogonal to the movement direction F of the substrate, a working effect similar to the above can be obtained. Or, as shown in FIG. 10, the movement direction F (relative movement direction) of the stage 2 (substrate 50) may be tilted from the beam scanning direction in the top view.

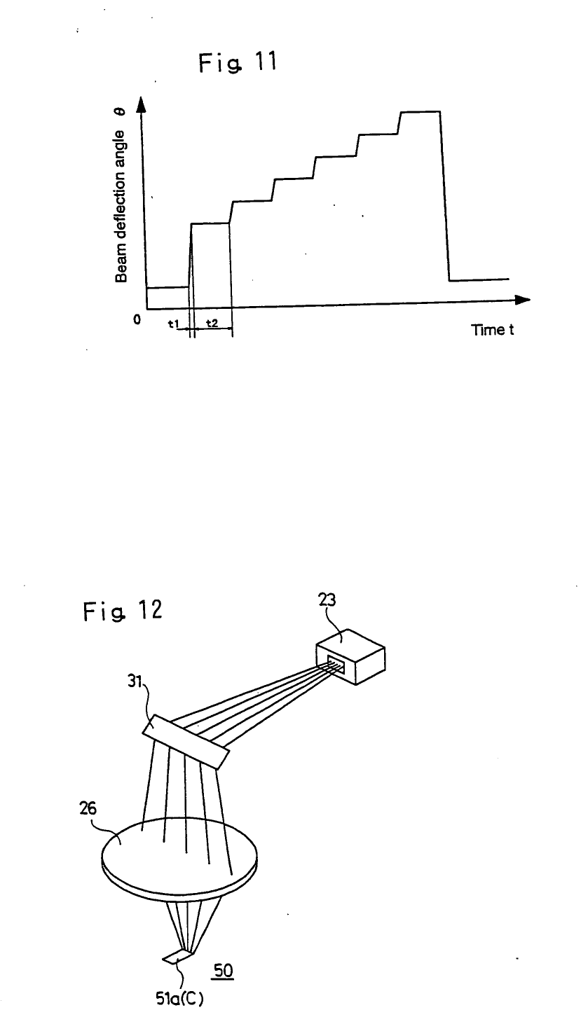

Concerning the laser beam to be used for the present invention, it may be a laser beam outputted continuously in addition to the one outputted in pulses if the deflection angle can be changed with high speed. As shown in FIG. 11, when a change-over time of the beam deflection angle 0 and a stable time of the beam deflection angle θ are expressed by t₁ and t₂, respectively, the beam is made to irradiate for both times. However, if the time t₁ is sufficiently short compared with the time t₂, and does not have an influence on the sensitivity of the resist, it is possible to expose a predetermined position.

Although the energy distribution in the laser beam is actually not homogeneous in many cases, the photoresist can be exposed even such a case if the energy is sufficient enough to be applied to the photoresist. Moreover, strictly speaking, the exposure points may not be formed in a complete square not only due to the actual exposure energy and photoresist sensitivity but also due to assembly errors of the optical system and surface reflection, or the like, but in most cases, this does not cause any problem to the visibility of the identification code. The beam can freely be formed to be round and polygonal by varying the shapes of the filter and lens, the interval between them, and their combination.

The embodiment shown in FIG. 1 explains the case in which a single laser beam is split into two branches by the beam splitter 21 for the use, but the number of the branches can be more than three, or the single beam can be used as it is without being split. Moreover, the beam splitter is not specially limited if it is able to split the beam, and another means such as a half-silvered mirror can be used.

Moreover, in the embodiment shown in FIG. 1, the laser beams 14a to 14f deflected by the beam deflection mechanism 23 are so arranged as to be made into parallel light through the lens 24. However, according to the present invention, it is not always essential to make the laser beams into parallel light, and as shown in FIG. 12, the substrate 50 can also be irradiated with the laser beams diverged by the beam deflection mechanism 23 and be exposed thereto by letting the mirror 31 reflect them without paralleling them and condense them again through an optical means 26 such as a condenser lens. Moreover, when condensing the deflected laser beams again, it does not matter whether the projection optical system to be used is a finite system or an infinite system, and is irrespective of the number of mirrors.

When the identification code is changed in direction, it is possible to mark the identification code by scanning the stage by changing the direction of scanning. When the identification code has been exposed, the stage is moved to the substrate conveyance position; the substrate is released from sticking by suction to raise the substrate holding pins; and then the substrate is carried out being mounted on the substrate conveyance mechanism. Thereafter, a series of operation is repeated, namely, an unexposed substrate is carried in again to perform exposure operation, and when the substrate has been exposed, it is carried out.

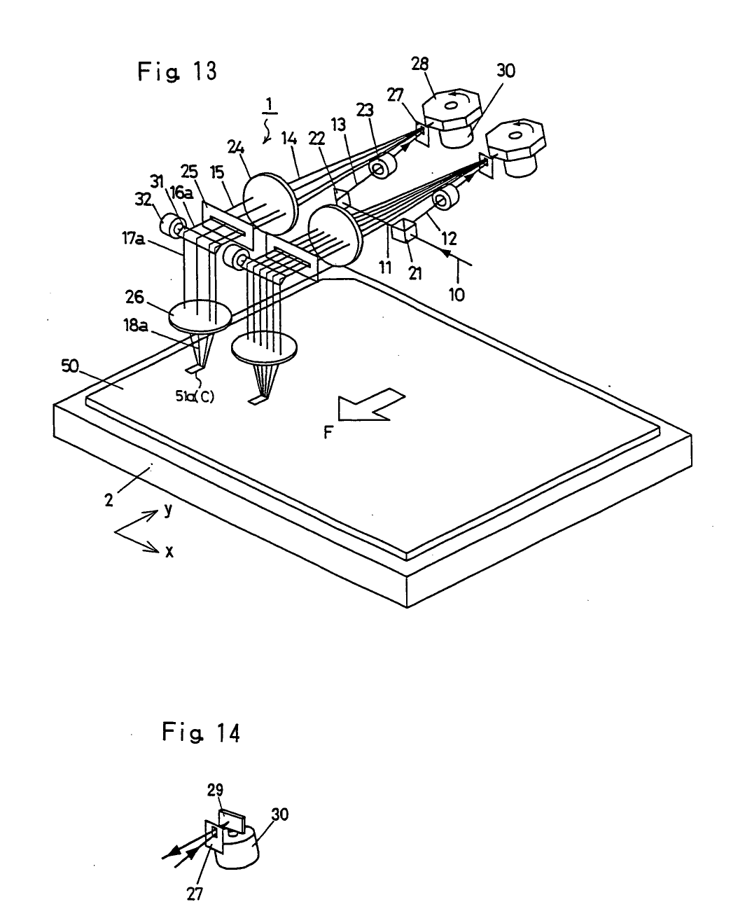

Moreover, in the embodiment shown in FIG. 1, the means for deflecting and splitting the laser beam is so arranged as to perform deflection and irradiation in a plurality of stages by the beam deflection mechanism 23. This means can also be arranged as shown by the embodiment in FIG. 13 so that the beam deflection mechanism 23 performs only selective irradiation of light outgoing or quenching, and the operation of deflecting the laser beams is performed by using the polygon mirror 28 rotated by the mirror rotating mechanism 30. Moreover, as the example shown in FIG. 14, a planar mirror 29 rotated left and right can also be used as the polygon mirror 28 in this case.

In the embodiment shown in FIG. 1, the exposure unit is fixedly arranged, and the stage 2 for holding the substrate is made independently movable in the directions of X- and Y-axes on an orthogonal coordinates. However, with this relationship inverted, the exposure unit 1 may be made independently movable in the directions of X- and Y-axes.

Moreover, when several exposure units are arranged side by side in a plurality of arrays, it is preferable that the exposure positions of the identification codes can arbitrarily changed by varying the intervals between these exposure units into arbitrary sizes by the moving mechanism.

According to the marking method and device of the present invention described above, scanning is performed by making the laser beam outputted from the exposure unit deflect and branch in time series and in order in the direction orthogonal to the relative movement direction between the exposure unit and the stage, and the direction of irradiation is corrected so as to eliminate a time difference of irradiation between the beams adjacent to each other in the direction orthogonal to the relative movement direction, therefore, each beam does not largely vary in the energy distribution and form, and an identification code homogeneous in the form and density can be marked.

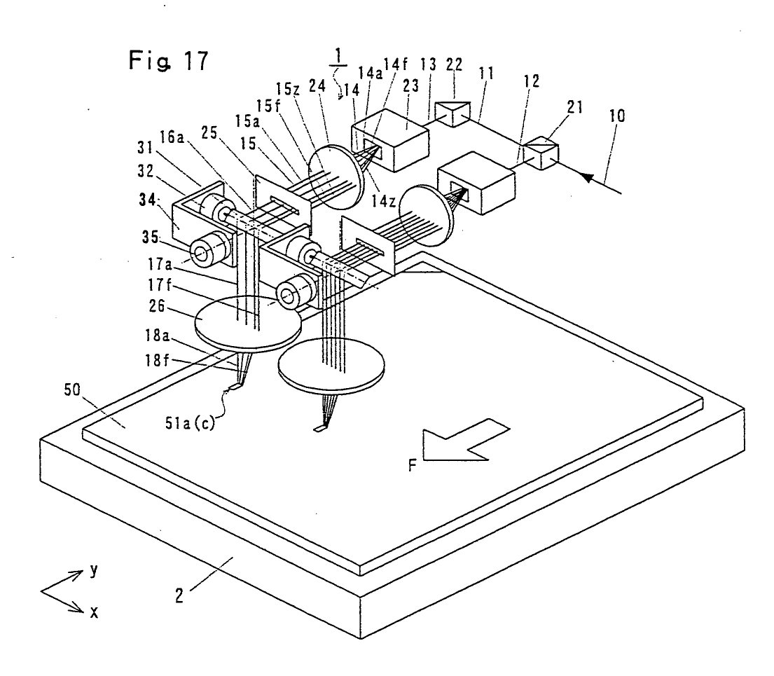

FIG. 17 shows an example of a device for marking an identification code by means of a laser beam according to the present invention for achieving the latter purpose mentioned above.

In FIG. 17, an exposure unit 1, a stage 2, a substrate 50 which is held on this stage 2 and the article to be marked, or the like are the same devices as those shown in FIG. 1 as examples. The substrate 50 is coated with a photosensitive resin (photoresist) on the surface.

The above-mentioned substrate 50 is carried in by a conveyance mechanism such as an unillustrated transfer robot and conveyor, to be mounted on the stage 2. Moreover, it is also the same with the case of FIG. 1 that the stage 2 is provided with driving mechanisms moving independently in the directions of X- and Y-axes of the orthogonal coordinates, and a rotary drive mechanism for turning the stage centering the axis vertical to the surface center of the stage 2, and is thereby capable of performing horizontal movement in the directions of X- and Y-axes and also rotational movement.

Moreover, it is also the same with the case of FIG. 1 that a single laser beam 10 outputted from the laser light source is split by the exposure unit 1; the laser beams 12, 13 split into two are respectively transformed into the laser beams 14 to 14z deflected in time series at different angles by the beam deflection mechanism 23; these are parallelized into parallel beams 15 to 15z through the lens 24; and further, the beams in the excessive range are cut off by processing them through the transmission filter 25 as shown in FIG. 3.

The laser beams 16a to 16f selected through the filter 25 as described above are changed in irradiation angles by an optical angle varying means such as the mirror 31. The laser beams 17a to 17f changed in angles by the mirror 31 are condensed into the laser beams 18a to 18f through the lens 26, and irradiate the photoresist-coated substrate 50 to expose the photoresist. A lens called an Fθ lens is generally used for the lens 26, but other lenses can be used and a combination of the other optical members can be used.

In the marking device according to the present invention of the constitution described above, the rotary shaft of the above-mentioned mirror 31 is provided with a rotary mechanism 32, and the mirror 31 is slantingly moved to shift the directions of irradiation of the laser beams 17a to 17f reflecting on the mirror 31 in the direction of Y-axis. Further, another rotary mechanism 35 having a rotary shaft in the direction orthogonal to the rotary shaft of the rotary mechanism 32 is installed on an L-shaped mounting 34 for supporting this rotary mechanism 32 so that the directions of irradiation of the laser beams 17a to 17f reflecting on the mirror 31 can be shifted in the direction of X-axis by turning this rotary mechanism 35.

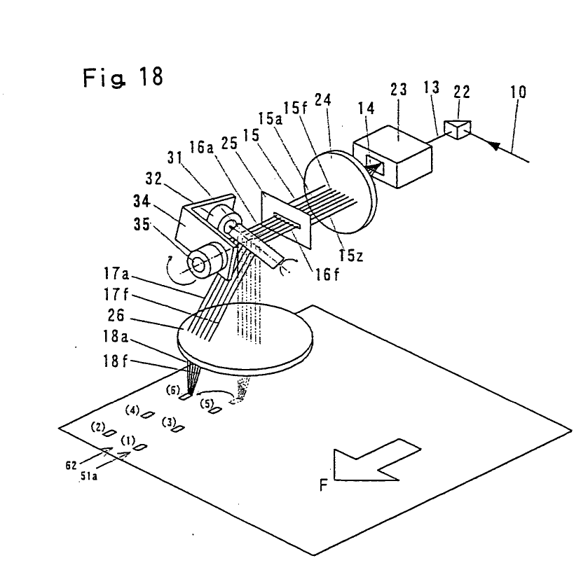

The rotary mechanism 32 of the above-mentioned mirror 31 and the rotary mechanism 35 of the mounting 34 constitute the angle varying means of the laser beam irradiation direction in the present invention. As shown in FIG. 18, when each of the rotary mechanisms 32 and 35 is made to turn by a small angle, the irradiate position of the laser beams 17a to 17f, 18a to 18f on the substrate 50 can be changed from the position indicated by a chain line (the position indicated by a full line in FIG. 17) to the diagonally rear position indicated by a full line.

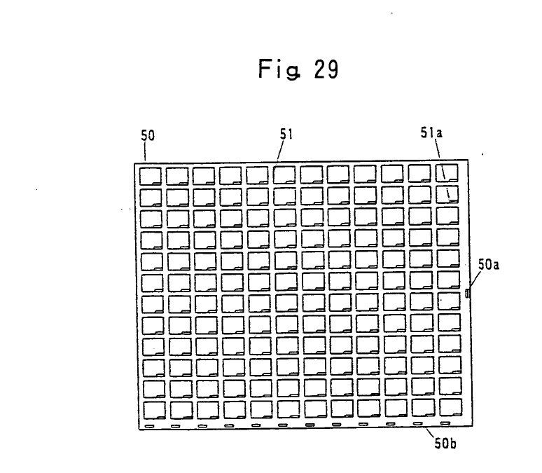

Next, it will be explained how to mark a panel identification code 51a on each of 12 sheets×12 sheets (=144 sheets) of liquid crystal panels 51 formed on the substrate 50 as shown in FIG. 29 by using the marking device according to the present invention described above. The identification code is formed out of characters and/or two-dimensional figure(s).

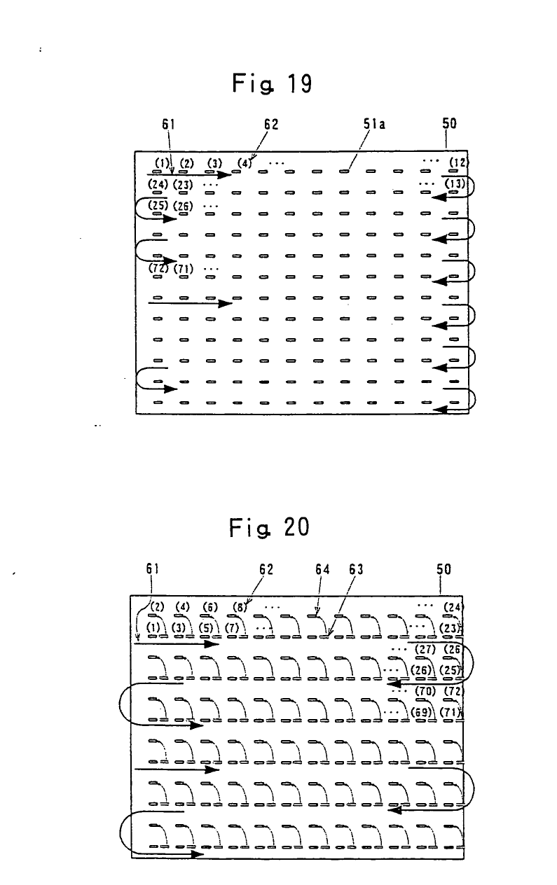

Firstly, in the case of a device not provided with the above-mentioned angle deflection means, when the stage 2 is moved with respect to the exposure unit 1, as shown in FIG. 19, each row of the panel identification codes 51a is selectively irradiated with the laser beam in time series by the exposure unit 1 in order 62 of irradiation (1), (2), (3), . . . in the direction 61 of scanning and irradiation, to expose the identification codes 51a arrayed at a constant pitch. In this case, if only one exposure unit 1 is arranged, each row scanning irradiation has to be performed 12 times, and if two exposure units 1 are arranged, each row scanning irradiation needs to be performed 6 times by each unit.

However, if the above-mentioned angle varying means is used, as shown in FIG. 20, two rows of marking can be performed by one pass of irradiation.

Namely, when one pass of irradiation is carried out, marking is performed (refer to FIG. 20) so that two rows of the identification codes 51a are arrayed at a constant pitch in the direction 61 of scanning irradiation, while alternately changing a position to be irradiated with the laser beams 17a to 17f, 18a to 18f onto the substrate 50 for a position illustrated by the full line as explained in FIG. 18.

Namely, when the order numbers expressed by the irradiation order 62 (1), (2), (3), . . . are odd-numbered, the turning angle of the angle varying means is made to the posture of the chain line shown in FIG. 18, and when they are even-numbered, the turning angle of the angle varying means is made to the posture of the full line shown in FIG. 3, and thus marking is performed so two rows of the identification codes 51a are arrayed at a constant pitch, by changing the postures in time series and selecting the direction of irradiation of the laser beams.

In other word, in an array in irradiate order of (1), (3), (5), during the blank period between the end of marking the identification code No. (1) and the start of marking the following identification code No. (3), marking of the identification code No. (2) in the adjacent array is performed. During the blank period between the end of marking the identification code No.(3) and the start of marking the identification code No.(5), marking of the identification code No.(4) in the adjacent array is performed. Also, in an array in irradiate order of (2), (4), (6), during the blank period between the end of marking the identification code No.(2) and the start of marking the following identification code No.(4), marking of the identification code No.(3)in the adjacent array is performed, and during the blank period between the end of marking the identification code No.(4) and the start of marking the identification code No.(6), marking of the identification code No.(5) in the adjacent array is performed.

Thus, marking of the identification codes is performed in units of a plurality of arrays when one pass of irradiation is carried out, therefore, if two exposure units 1 are arranged as shown in FIG. 17, the scanning irradiation is required only three times for one board of substrate 50, and it is required six times when only one exposure unit is arranged. Therefore, it becomes possible to mark double number or more of identification codes in the same period compared with the conventional marking method.

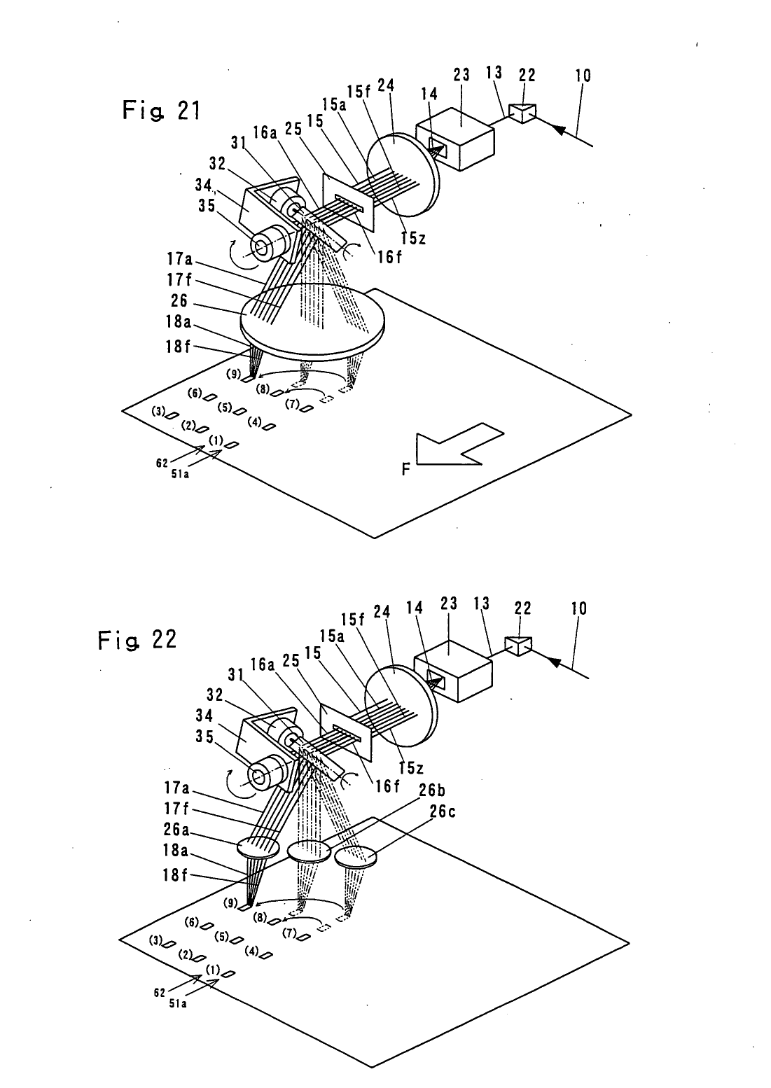

The embodiment stated above has explained the case in which two arrays of identification codes are marked in one pass of irradiation by varying the angle of the angle varying means at two steps, but as long as the blank period within the pitch of the identification codes allows, the angle can be varied at three steps or more as shown in FIG. 21. Moreover, as shown in FIG. 21, only a single condensing lens can be used then, but condensing lenses 26a, 26b, 26c can be arranged for each step as an example shown in FIG. 22. In this case, it goes without saying that the number of the lenses 26a, 26b, 26c varies according to the irradiate directions to be varied, and that each position can be adjusted by the position adjusting mechanism (not illustrated).

Moreover, in the above-stated embodiment, a marking device of such constitution is explained, as the exposure unit 1 is fixedly arranged at a predetermined position, and the substrate holding stage 2 is moved in the directions of X- and Y-axes of orthogonal coordinates and also turned, but in reverse, the exposure unit 1 can be arrange so as to be moved in the direction of X- and Y-directions and also turned. Moreover, the number of the exposure unit 1 may be one.

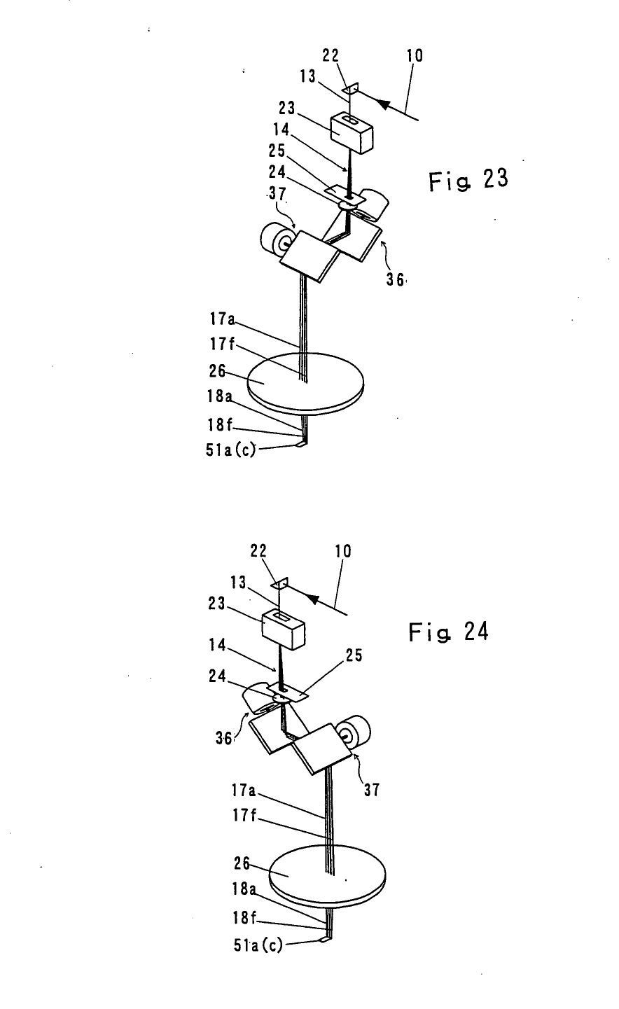

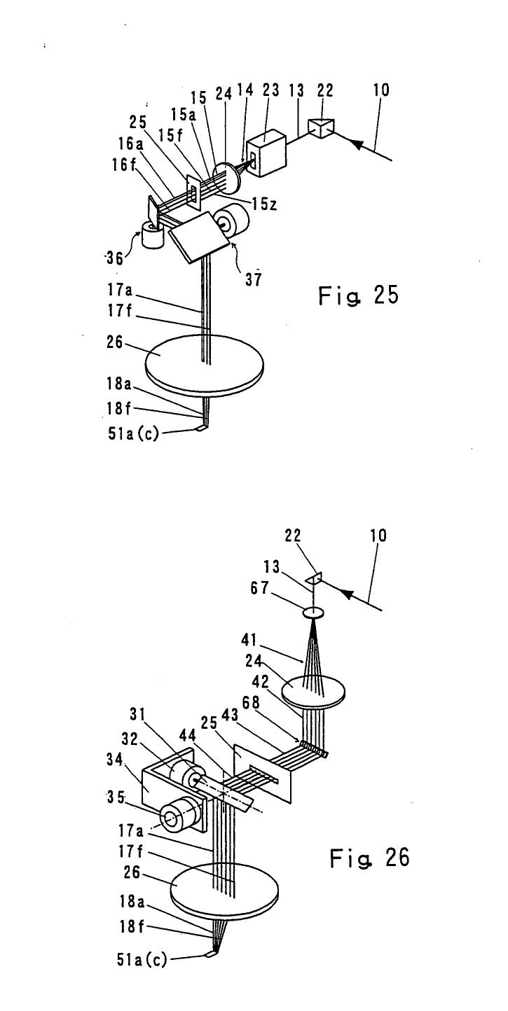

An example of a combination of the rotary mechanisms 32 and 35 is shown, but as shown in FIG. 23, for example, a mirror angle varying mechanism using galvanometer scanners 36, 37 can be combined therewith. Moreover, as an angle varying means, the galvanometer scanners 36, 37 can be positioned and combined as exemplified in FIG. 24 and FIG. 25.

Further, as a means of splitting a laser beam into two or more, a beam splitting filter 67 such as a diffraction optical element as shown in FIG. 26 can be used in addition to the beam deflection mechanism 23. The laser beams 41 split by this beam splitting filter 67 are made into parallel laser beams 42 through the lens 24, and each of the laser beams 42 independently irradiates the angle varying mechanism 68. These laser beams 43 reflected by the angle varying mechanism 68 travel as the laser beams 44 selectively outgone through the transmission filter 25, and further travel as the laser beams 17a to 17f changed in angles by the mirror 31. As another means for split-outgoing the beams in addition to the above, a method of utilizing a polygon mirror represented by a galvanometer scanner or a polygon mirror and other means can be used.

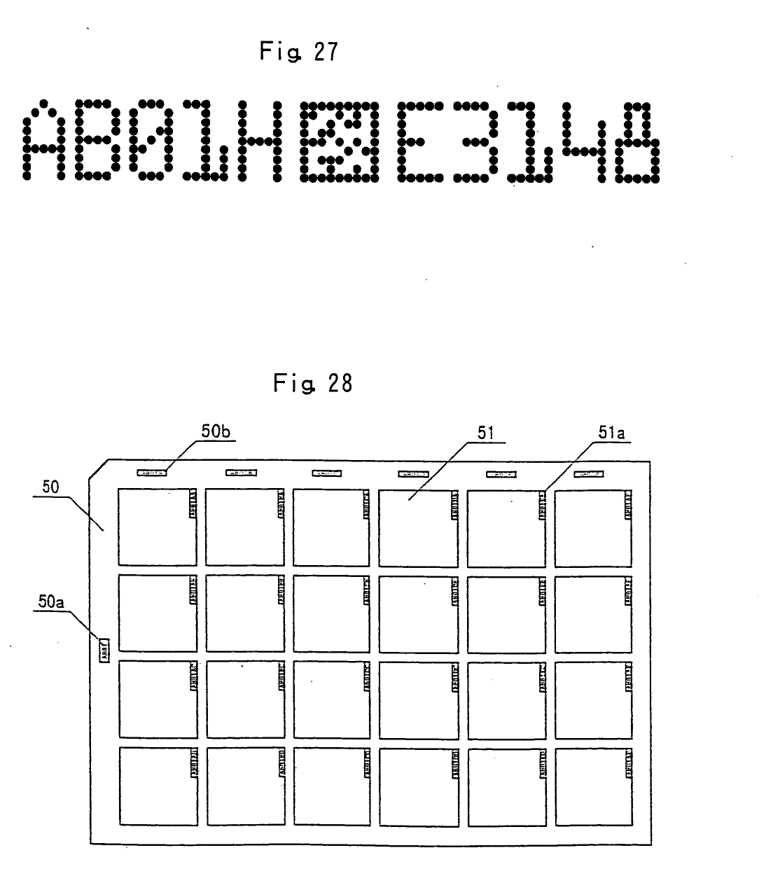

Moreover, in the embodiment, to brief the explanation, the primary laser beams 16a to 16f selectively outgone at six steps and the primary laser beam 15z to be shaded are illustrated. However, in actual marking, it goes without saying that there are such cases as an arrangement with 9-steps or less as shown in FIG. 27, and a further sub-divided arrangement with 10-steps or more, and any number of angle change-over steps can be arranged as desired.

Moreover, in the embodiment, the explanation is made in the case of splitting the laser beam 10 into two, but it does not matter whether the laser beam 10 is not split or it is split into multiple beams by using a plurality of beam splitters. Further, since the beam splitter 21 is a means for splitting light, another means such as a half-silvered mirror can be used of course. Moreover, an example is shown in which two exposure units 1 are arranged in parallel, but it goes without saying that the interval between them can be made movable by a moving mechanism (not illustrated) and thereby the marking positions of identification codes can be varied arbitrarily.

According to the present invention stated above, since the device is arranged to be able to mark a plurality of arrays by marking the adjacent array of identification codes by utilizing the blank period in which the exposure unit 1 is relatively moving by one pitch, twice or more number of identification codes can be marked during the same one pitch relative movement as that in the conventional marking method.

Further, since it is not necessary to increase the number of the exposure units even if the number of arrays for marking is increased, the device is not upsized, but can be simplified or downsized.

### EXAMPLE 1

In order to mark identification codes on a photoresist-coated substrate by an identification code marking device shown in FIG. 1, a laser beam near the third harmonic wavelength λ=355 nm of a YAG laser is used as the laser beam, and a resin photosensitive with this wavelength is selected as the photoresist to be applied to the substrate.

A pulse frequency f of the laser beam is set to f=60 kHz, and a laser beam width W on the working plane is set to W=0.050 mm when condensed on the substrate, an interval p between adjacent beams is set to P=0.050 mm, and speed v for moving the stage in the direction of the beam width is set to v=50 mm/sec.

Moreover, the laser beam is deflected at seven steps by the beam deflection mechanism, and is arranged so that six directional beams among them pass through the filter 25 to irradiate the substrate, and the six directional beams are made to selectively irradiate at 10 kHz.

From the above settings, a stage moving distance D at one pulse interval of the laser beam is expressed by
D=v/f

and a displacement between adjacent beams is 0.0083 (mm), and an interval between the beams of the next arrays is
D=6×500/60000=0.05 (mm)

Further, an ON period during one pulse is expressed by tₐ, an OFF period by t_{b}, and a duty ratio is defined as
r=tₐ/(tₐ+t_{b})

and set to r=10%, then a laser irradiation time tₐ per one pulse is expressed by
tₐ=r/f

When the length of the laser beam on the working plane is expressed by d, and d is made to d=0.045 mm, the actual irradiation length L is expressed by
L=d+v·tₐ
L=d+v·r/f

and L is obtained as L=0.050 mm, therefore, the exposure can be performed with each laser beam in a grid pattern at an interval of 50 μm.

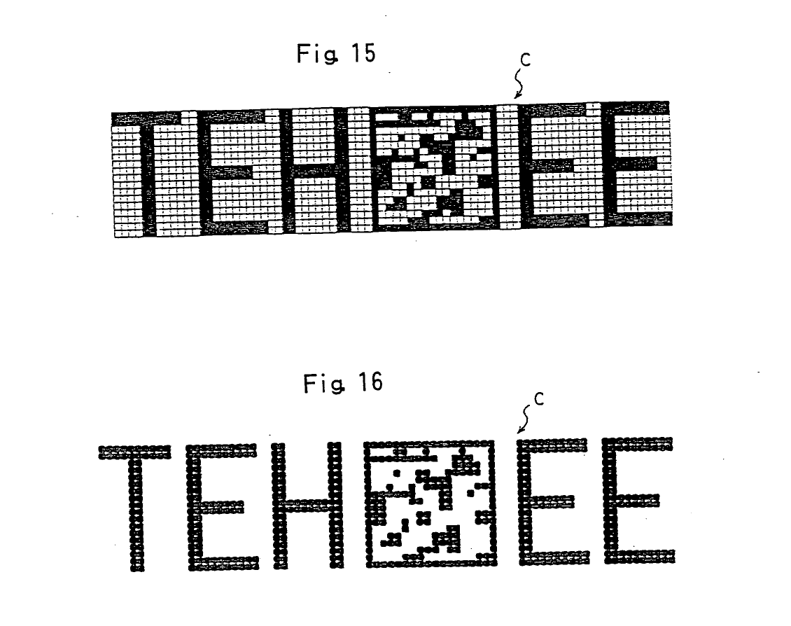

The identification code of a dotted pattern consisting of characters and a figure can be formed as shown in FIG. 15 by repeating the above.

Moreover, without being limited to FIG. 15, the dot form pattern can be varied variously by varying the scanning speed v of the substrate and the size of the identification code. For example, it can be varied into the one with dots with rounded corners or round dots, or other geometrical figures as shown in FIG. 16, and these can be recognized as an identification code.

### EXAMPLE 2

In order to mark identification codes on the substrate by the identification code marking device shown in FIG. 1, a laser beam near the third harmonic wavelength λ=355 nm of a YAG laser is used as a laser beam, and a resin photosensitive with this wavelength is selected as the photoresist to be applied to the substrate.

It is assumed that each identification code is constituted of a grid of 20 dot height×100 dot length, and is 2 mm height×1 mm length in size. Namely, the distance between adjacent dot centers, the dot pitch is 0.1 mm.

The pulse frequency f of the laser beam is set to 60 kHz, and the beam is made to deflect and irradiate in time series in the direction of the height of the identification code by the beam varying mechanism 23. At this time, the next pulse of 3 kHz is outputted in the longitudinal direction of the identification code for selective irradiation.

Then, if the moving speed v of the stage is set to v=300 mm, the dot pitch dy in the longitudinal direction of the identification code is obtained as dy=0.1 mm.

It is assumed that the long side length of a glass substrate is Lx=650 mm and the short side length is Ly=550 mm.

As shown in FIG. 29, a glass substrate is divided vertically and horizontally into 12×12 pieces of panels, and an identification code is to be marked onto each panel having a long side length px=54 mm and a short side length py=40 mm.

When the conventional method is used with two exposure units, scanning exposure operation has to be performed 6 times as shown in FIG. 19. Then, the identification code to be exposed is 10 mm long and exposure marking is to be performed in the long side direction of each panel. In this case, the 44 mm length from the exposure end position up to the next exposure start position has required a time for moving.

As shown in FIG. 20, necessary exposure is completed by three-time scanning operation by performing the exposure operation distributed in the two directions within one pass of exposure by the method of the present invention. Moreover, if the operation distributed in three positions is performed as shown in FIG. 21, the necessary exposure is completed by two-time scanning operation. Further, if the exposure unit is increased in number, each scanning operation can be decreased in frequency.

In any case of the above, the marking is performed on the adjacent array and/or other array(s) during the period in which identification codes have not been exposed by the conventional method. Therefore, since it takes a similar time for one-time scanning irradiation, a processing time for one substrate can be shorten by reducing the frequency of scanning irradiation, and an hourly processing rate of substrates, namely, the through-put can be increased.

The scanning speed v of the substrate and the dimensions of the code presented here are only for examples, and vary depending on a mode actually employed. Moreover, the dot pattern does not need to be an accurate round or rectangle, and even in cases of using a triangle, a hexagon, other polygons, and those with rounded corners, or a shape consisting of other geometric figures, connected dots, or independent dots, these can be recognized as an identification code.

Although the energy distribution is actually not homogeneous in the beam in many cases, the resist can be exposed if the energy is sufficient for the resist. Moreover, an identification code is sometimes not formed into a precise and complete square not only due to actual exposure energy and sensitivity of the resist but also due to assembly errors of the optical system and surface reflection or the like, but these do not cause any problem to the identification code in most cases.

The various data mentioned in this embodiment are only for examples, and a beam form can freely be changed into a round, a polygon, or the like by changing the shapes of the filter and lens, the interval between them, and a combination thereof. Moreover, a laser beam of a continuous wave other than the pulse beam used for this embodiment is also applicable.

In addition, in this embodiment, exposure marking on a photoresist-coated substrate is explained, but this method is also effective in the cases of not only exposing with other wavelengths by changing the kind of laser to be used but also engraving (direct marking) on a substrate with metallic deposition, a glass substrate, and a silicon wafer substrate.

### INDUSTRIAL APPLICABILITY

The present invention described above is applicable not only to the marking by exposing a photoresist-coated substrate with a laser beam, but also to the marking by directly engraving (direct marking) on a substrate with metallic deposition, a glass substrate, and a silicon wafer substrate.

What is claimed is:

1. A method for marking an identification code on a liquid crystal panel by means of a laser beam, comprising steps of
moving a stage mounted with the liquid crystal panel and an exposure unit arranged above the stage relatively to each other, and
marking the identification code on the liquid crystal panel by means of the laser beam outputted from the exposure unit, wherein
the irradiated points on the liquid crystal panel are arranged in orthogonal coordinates of the liquid crystal panel by letting the laser beam outputted from the exposure unit scan so as to deflect in time series in order in the direction perpendicular to said relative movement direction, and also by shifting the direction of irradiation in said relative movement direction.

2. The method for marking the identification code on the liquid crystal panel by means of the laser beam as claimed in claim 1, wherein the identification code is composed of at least either characters or two-dimensional figure(s).

3. A method for marking an identification code on a liquid crystal panel by means of a laser beam, comprising steps of
moving a stage mounted with the liquid crystal panel and an exposure unit arranged above the stage relatively to each other, and
marking the identification code on the liquid crystal panel by means of the laser beam outputted from the exposure unit, wherein
the irradiated points on the liquid crystal panel are arranged in orthogonal coordinates of the liquid crystal panel by tilting the orthogonal coordinates on the surface of the stage or the liquid crystal panel on the stage with respect to said relative movement direction, and letting the laser beam outputted from the exposure unit scan so as to deflect in time series in order in the direction orthogonal to the relative movement direction.

4. The method for marking the identification code on the liquid crystal panel by means of the laser beam as claimed in claim 3, wherein the identification code is composed of at least either characters or two-dimensional figure(s).

5. A device for marking an identification code on a liquid crystal panel by means of a laser beam, comprising
a stage for mounting thereon the liquid crystal panel and an exposure unit arranged above the stage so that they are relatively movable to each other, wherein the exposure unit is comprised of a beam deflection means for letting the laser beam outputted from the exposure unit scan so as to deflect in time series in order in the direction orthogonal to the relative movement direction, and a direction correction means for shifting the irradiation direction of the laser beam deflected by the beam deflection means in the relative movement direction.

6. The device for marking the identification code on the liquid crystal panel by means of the laser beam as claimed in claim 5, wherein the direction correction means is a reflection plane variable mirror.

7. The device for marking the identification code on the liquid crystal panel by means of the laser beam as claimed in claim 6, wherein a condensing means is arranged downstream from the direction correction means.

8. The device for marking the identification code on the liquid crystal panel by means of the laser beam as claimed in claim 5, wherein a condensing means is arranged downstream from the direction correction means.

9. The device for marking the identification code on the liquid crystal panel by means of the laser beam as claimed in claim 5, wherein two or more rows of said exposure units are arranged.

10. A device for marking an identification code on a liquid crystal panel by means of a laser beam, comprising
a stage for mounting thereon the liquid crystal panel and an exposure unit arranged above the stage so that they are relatively movable to each other, wherein the exposure unit comprises a beam deflection means for tilting the orthogonal coordinates on the surface of the stage or the liquid crystal panel on the stage with respect to the relative movement direction and letting the laser beam outputted from the exposure unit scan so as to deflect in time series in order in the direction orthogonal to the relative movement direction, a projection optical means for magnifying the laser beam deflected by the beam deflection means, and a direction correction means for changing the irradiate direction of the laser beam projected from the projection optical means.

11. The device for marking the identification code on the liquid crystal panel by means of the laser beam as claimed in claim 10, wherein two or more rows of said exposure units are arranged.
